(19) United States
(12) Patent Application Publication
(10) Pub. No.: US 2013/0017440 A1
(43) Pub. Date: Jan. 17, 2013

(54) ELECTRODE FOR SECONDARY CELL, METHOD FOR PRODUCING THE SAME, AND SECONDARY CELL

(71) Applicant: Yasuo TAKANO, Yokohama-shi (JP)

(72) Inventor: Yasuo TAKANO, Yokohama-shi (JP)

(73) Assignee: SAMSUNG YOKOHAMA RESEARCH INSTITUTE CO., LTD., Yokohama-shi (JP)

(21) Appl. No.: 13/352,966

(22) Filed: Jan. 18, 2012

(30) Foreign Application Priority Data
Jul. 15, 2011 (JP) 2011-157241

(51) Int. Cl. H01M 4/66; H01M 4/04; B05D 5/12

(52) U.S. Cl. 429/211; 427/77

(57) ABSTRACT

A secondary cell electrode includes a mix layer containing an active substance, a conductive agent, and a binder which is swollen by coexistence with an electrolytic solution and thus has a volume thereof increased; and a current collector formed of a conductive metal foil, the mix layer being located right on the current collector. The current collector has, in a surface thereof, a first concaved portion which is opened and a first convexed portion forming a wall of the first concaved portion; at least a part of a side surface of at least either one of the first concaved portion and the first convexed portion includes at least either one of a second concaved portion and a second convexed portion; and a mixture containing at least either one of the binder, the conductive material and the active substance is put into a space in the first concaved portion.

### CROSS REFERENCE TO RELATED APPLICATIONS

This application is based upon and claims the benefit of priority from the prior Japanese Patent Application No. 2011-157241, filed on Jul. 15, 2011, the entire contents of which are incorporated herein by reference.

### FIELD

The present invention relates to an electrode having minute concaved and convexed portions in a surface of a current collector, a method for producing the electrode, and a secondary cell using the electrode.

### BACKGROUND

Lithium-containing olivine-type lithium iron phosphate, when being charged/discharged while being used in a cell, causes a lithium insertion/deinsertion reaction to proceed slowly, and has a significantly lower electron conductivity than lithium cobalt oxide, lithium manganese oxide and the like which are conventionally used as a positive electrode active substance. Therefore, the cell using lithium-containing olivine-type lithium iron phosphate has a high internal resistance, and also causes a large polarization at the time of high-rate discharge.

In order to solve the above-described problems, Japanese Laid-Open Patent Publication No. 2002-110162 proposes reducing the particle diameter of lithium-containing olivine-type phosphate.

However, the technology described in Japanese Laid-Open Patent Publication No. 2002-110162 uses a positive electrode active substance having a small particle diameter and therefore has a problem that the adhesiveness between the active substance particles and a current collector is lowered.

WO2005/086260 discloses measures for alleviating the problem, by which the surface of the current collector of the positive electrode is roughened to increase the surface area of the current collector and a positive mix is located on the current collector.

Surface roughening by a blast method used in WO2005/086260 can increase the surface area of the current collector of the positive electrode but can only obtain relatively smooth concaved and convexed portions. Therefore, the surface area of the current collector is increased, but the following problem is caused. Under the condition that an electrolytic solution is coexistent, a binder absorbs the electrolytic solution to be swollen, and a stress is caused at an interface between a layer of the positive mix and the current collector. As a result, the positive mix layer is detached from the interface with the current collector, and thus the internal resistance of the cell is increased.

In light of the above-described problems, an object of the present invention is to provide an electrode for a lithium secondary cell including a current collector having a surface of a shape which, even when a binder stacked on the surface absorbs an electrolytic solution and thus is swollen and deformed, does not allow the binder to be detached easily from the surface of the current collector, and a method for producing the same. Another object of the present invention is to provide a lithium secondary cell including the electrode. (In this specification, an electrode for a secondary cell will be referred to as the “secondary cell electrode”.)

### SUMMARY

The present invention is directed to a secondary cell electrode including a mix layer containing an active substance, a conductive agent, and a binder which is swollen by coexistence with an electrolytic solution and thus has a volume thereof increased; and a current collector formed of a conductive metal foil, the mix layer being located right on the current collector. The current collector has, in a surface thereof, a first concaved portion which is opened and a first convexed portion forming a wall of the first concaved portion; at least a part of a side surface of at least either one of the first concaved portion and the first convexed portion has at least either one of a second concaved portion and a second convexed portion; and a mixture containing at least either one of the binder, the conductive material and the active substance is put into a space in the first concaved portion.

According to the present invention, with the above-described structure, it is preferable that the surface of the current collector has a surface roughness (Ra) of 0.21 μm or larger. There is no specific limitation on the upper limit of the surface roughness as long as the durability of the surface of the current collector is maintained and the effect of preventing the mix layer or the active substance from being detached or coming off is exhibited. However, when the surface roughness (Ra) is too large, there is an undesirable possibility that the strength of the concaved and convexed portions is lowered. Therefore, in the case where an aluminum foil is used as the current collector, it is preferable that the upper limit of Ra is 1.0 μm.

One embodiment according to the present invention is characterized in that, regarding the first concaved portion and the first convexed portion formed in the surface of the current collector by a chemical technique such as a chemical etching method, an electrolytic etching method or the like, at least a part of a side surface of the first convexed portion has a warped shape which is extended outward as approaching a tip thereof. The present invention is characterized in that a mixture, containing a binder which is swollen by coexistence with an electrolytic solution and thus has a volume thereof increased and at least one of an auxiliary conductive agent and an active substance, is put into the first concaved portion.

The current collector in one embodiment according to the present invention has the first concaved portion opened upward in a surface thereof, and at least a part of a side surface of the first convexed portion forming a wall of the first concaved portion, has a warped shape which is extended outward as approaching a tip thereof. Owing to this, the contact area between the mix layer and the current collector can be increased, and thus the adhesiveness between the mix layer and the current collector can be improved. As a result, the secondary cell electrode according to the present invention can suppress the mix layer or the active substance from being detached from the current collector, and thus suppresses the internal resistance of the cell.

### BRIEF DESCRIPTION OF THE DRAWINGS

FIG. 1 is a schematic view of a secondary cell electrode in one embodiment according to the present invention;

FIGS. 2(a) and 2(b) are each a schematic view of a current collector of a secondary cell electrode in other embodiments according to the present invention;

FIG. 3 is an image of a cross-section of an electrode using an aluminum foil (a1) having a usual smooth surface, which is observed by an SEM;

FIG. 4 is an image of a cross-section of an electrode using a surface-roughened aluminum foil (c2) formed by a chemical etching method, which is observed by an SEM;

FIG. 5 is an image of a cross-section of an electrode using a surface-roughened aluminum foil (d4) formed by an electrolytic etching method, which is observed by an SEM;

FIG. 6 is a schematic cross-sectional view of inventive cells 1 through 5 according to the present invention and comparative cells 1 through 4;

FIG. 7 is an image of a cross-section of an electrode using an aluminum foil (d4) that is not treated by chemical etching, which is observed by an SEM;

FIG. 8 is an image of a cross-section of an electrode using surface-roughened aluminum foil 1 formed by a chemical etching method, which is observed by an SEM;

FIG. 9 is an image of a cross-section of an electrode using surface-roughened aluminum foil 2 formed by a chemical etching method, which is observed by an SEM; and

FIG. 10 is a graph showing results of a charge/discharge test and a high-rate discharge test performed on the aluminum foils shown in FIG. 7 through FIG. 9 in a usually used zone of a mobile-use cell.

### DESCRIPTION OF EMBODIMENTS

The above-described shape of the concaved and convexed portions in a surface of a current collector of a secondary cell electrode according to the present invention can be formed by a chemical etching method or an electrolytic etching method as follows.

### First Embodiment

### (Production of a Secondary Cell Electrode Using a Chemical Etching Method (1))

In the case where the current collector is formed of an aluminum foil, a surface roughening agent for aluminum or an aluminum alloy is used, which is formed of an aqueous solution containing 5 to 30% by weight (hereinafter, “%” means “% by weight”) of an inorganic acid, 1.5 to 9% of iron ions as a ferric ion source, 0.02 to 1.5% of manganese ions as a manganese ion source, and 0.05 to 1% of copper ions as a cupric ion source,

In this case, examples of the inorganic acid include hydrochloric acid, sulfuric acid, nitric acid, phosphoric acid, perchloric acid, sulfamic acid and the like. The inorganic acid has a concentration of 5 to 30%, preferably of 7 to 25%, and more preferably of 12 to 18%. When the concentration is lower than 5%, the roughening speed of aluminum is too low. When the concentration exceeds 30%, the aluminum salt is easily crystallized when the temperature of the solution is lowered. This has an undesirable possibility of decreasing the operability as a result of, for example, clogging a spray nozzle.

Examples of the ferric ion source include ferric nitrate, ferric sulfate, ferric chloride and the like. The concentration of the ferric ion source as the concentration of iron ions is 1.5 to 9%, preferably 2.5 to 7%, and more preferably 4 to 6%. When the concentration is lower than 1.5%, the roughening speed of aluminum is too low. When the concentration exceeds 9%, the roughening speed is too high and as a result, it is difficult to perform uniform roughening.

The concentration of the manganese ion source as the concentration of manganese ions is 0.02 to 1.5%, preferably 0.06 to 0.6%, and more preferably 0.1 to 0.5%. When the concentration is lower than 0.02%, the effect of adding the manganese ion source is not sufficiently provided. When the concentration exceeds 1.5%, the effect is not improved to the extent that matches the increase of the amount.

Examples of the cupric ion source include cupric sulfate, cupric chloride, cupric nitrate, cupric hydroxide and the like. The concentration of the cupric ion source as the concentration of copper ions is 0.05 to 1%, preferably 0.01 to 0.8%, and more preferably 0.15 to 0.4%. When the concentration is lower than 0.05%, it is difficult to remove the oxide layer. When the concentration exceeds 1%, replacement and deposit of copper metal easily occurs on the aluminum surface.

For roughening the surface of the current collector by use of a surface roughening agent, in the case where the aluminum surface is contaminated with machine oil or the like, the surface is degreased before being treated with the surface roughening agent. Examples of the method for treatment by use of the surface roughening agent include an immersion method and a spray method. The treatment is preferably performed at a temperature of 20 to 30° C. for a time duration of about 10 to 120 seconds. As a result of this treatment, the aluminum or aluminum alloy surface is formed into a shape of deep concaved portions and high convexed portions.

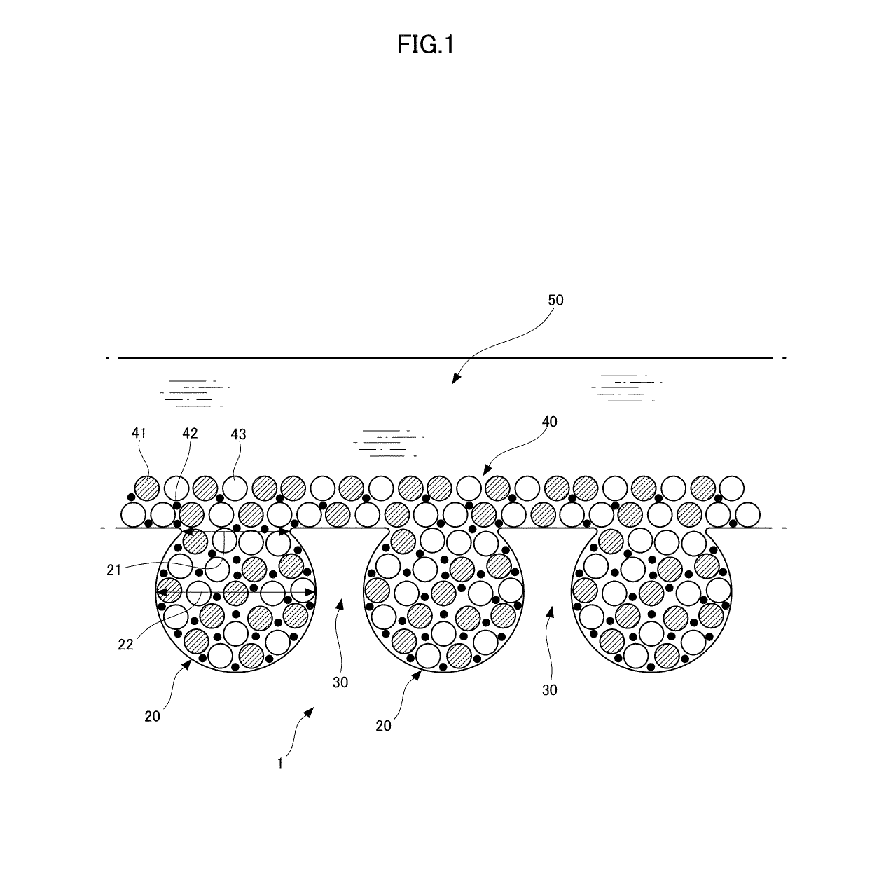

As shown in FIG. 1, a current collector 1 in one embodiment according to the present invention has, in a surface thereof, first concaved portions which are opened upward. First convexed portions form walls of the first concaved portions, and at least a part of a side surface of each first convexed portion has a warped shape which is extended outward as approaching a tip thereof. Because of this, a contact area between the mix layer mentioned above and the current collector can be increased and thus the adhesiveness of the mix layer and the current collector can be improved.

FIG. 1 shows the current collector 1 having the surface in which the first concaved portions 20 and the first convexed portions 30 are formed. The first concaved portions 20 each have an opening 21 having a size of about 1 μm on the average and a maximum inner size 22 of about 2 to 3 μm. The first convexed portions 30 are each formed between two such concaved portions 20 and each have a constricted side surface.

FIG. 1 shows a state where a mix layer 40 containing an active substance 41, a conductive material 42 and a binder 43 is swollen with an electrolytic solution 50 in the first concaved portions 20 and as a result, is prevented from being detached from the first concaved portions owing to an effect of preventing the mix layer or the active substance from being detached or coming off (hereinafter, referred to as the “anchor effect”).

The concaved and convexed shape of the current collector 1 according to the present invention is not limited to the shape shown in FIG. 1. Specifically, it is sufficient according to the present invention that at least a part of each of side surfaces of at least either the first concaved portions or the first convexed portions has at least either one of a second concaved portion or a second convexed portion, and that each of the first concaved portions has a space having a size sufficient for accommodating a mixture containing at least either one of the binder, the conductive material and the active substance.

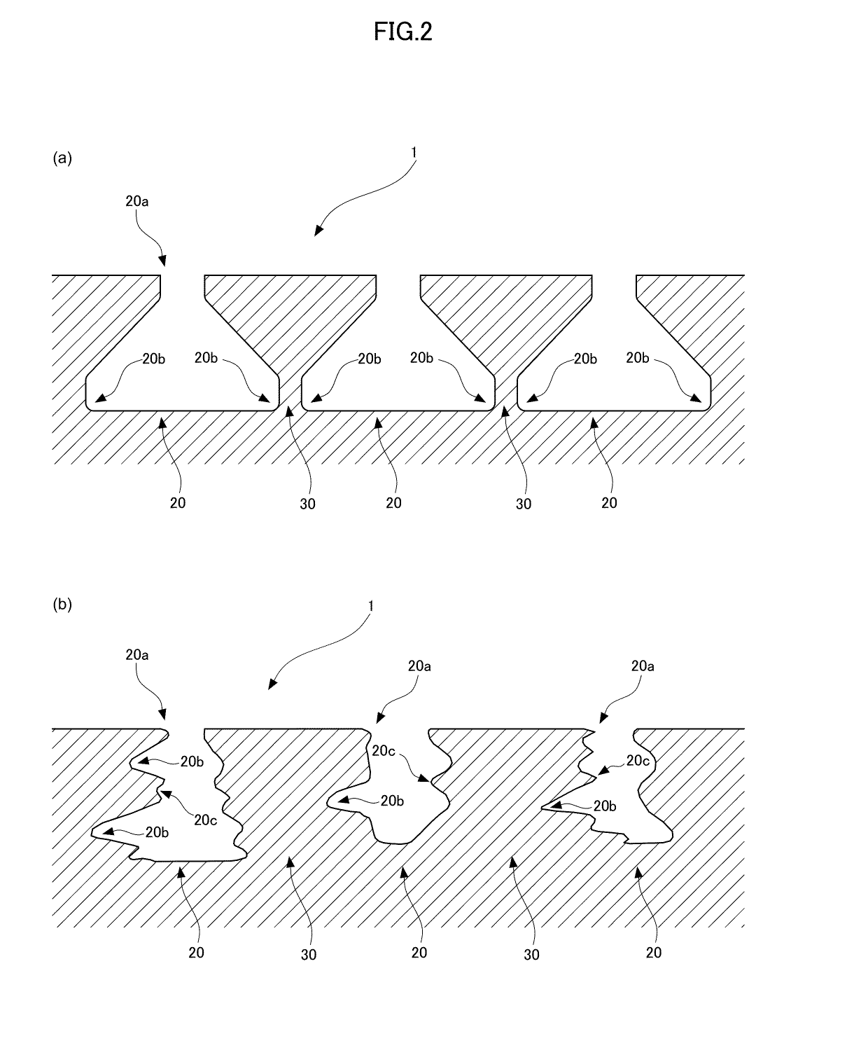

FIGS. 2(a) and 2(b) each show a modified example of the current collector 1 shown in FIG. 1 usable for the secondary cell electrode. FIG. 2(a) shows a current collector 1 having first concaved portions 20 of a truncated conical shape. The first concaved portions 20 each have a second concaved portion 20b in a bottom part thereof. The second concaved portion 20b is shaped like being cored in a depth direction opposite from an opening edge 20a thereof. FIG. 2(b) shows a current collector 1 having first concaved portions 20 and first convexed portions 30 each having a non-uniform side surface. The side surface of each first concaved portion 20 has a plurality of second concaved portions 20b and at least one second convexed portion 20c.

The roughening treatment by a blast method proposed in the conventional art is physical roughening. Therefore, the convexed portions of the concaved and convexed shapes each have a pyramid shape which is gradually tapered off as approaching a tip thereof. As a result, the adhesiveness is insufficient for successfully expressing the anchor effect.

Generally, a concaved and convexed portions formed by surface roughening by use of a physical technique such as a blasting method are formed of straight lines, and are relatively smooth. Therefore, a binder or a mixture of a binder and an active substance, even if once entering the concaved and convexed portion, is detached or flows easily. For this reason, the concaved and convexed portion formed by the blasting method cannot easily express the anchor effect as expressed by the present invention.

By contrast, a secondary cell electrode according to the present invention has the following feature. Under coexistence with an electrolytic solution, a binder or a mixture containing a binder, an active substance and a conductive material, which has entered the concaved and convexed portions formed in a surface of a current collector, is swollen because of the coexistence with an electrolytic solution and thus is strongly immobilized in the concaved and convexed portions. As a result, the secondary cell electrode according to the present invention can suppress the mix layer or the active substance from being detached from the current collector and thus can suppress the internal resistance of the cell.

### Second Embodiment

### (Production of a Secondary Cell Electrode Using a Chemical Etching Method (2))

A surface roughening agent formed of an aqueous solution containing a cupric complex of an azole and an organic acid and also having halogen ions added thereto is used. The cupric complex of an azole acts as an oxidant for oxidizing copper metal or the like. Among various types of cupric complex having such an oxidizing function, a cupric complex of an azole is used. Owing to this, an etching speed appropriate for a surface roughing agent can be expressed. Examples of the azole include diazole, triazole, tetrazole, derivatives thereof, and the like.

The cupric complex of an azole can be contained at a content which is appropriately set in accordance with the intended oxidizing power or the like. From the viewpoint of the solubility or the stability of the complex, the content is preferably 1 to 15% (hereinafter, “%” means “% by weight”). The cupric complex of an azole may be added as a copper complex. Alternatively, a cupric ion source and an azole may be separately added so as to form a copper complex in the solution. Preferable examples of the cupric ion source include copper hydroxide, and copper salts of organic acids described later.

The organic acid is incorporated for the purpose of dissolving copper oxidized by the cupric complex of an azole. Specific examples of the organic acid include saturated fatty acids such as formic acid, acetic acid, propionic acid, butyric acid, valeric acid, caproic acid and the like; unsaturated fatty acids such as acrylic acid, crotonic acid, isocrotonic acid and the like; aliphatic saturated dicarboxylic acids such as oxalic acid, malonic acid, succinic acid, glutaric acid, adipic acid, pimelic acid and the like; aliphatic unsaturated dicarboxylic acids such as maleic acid and the like; aromatic dicarboxylic acids such as benzoic acid, phthalic acid, cinnamic acid and the like; oxycarboxylic acids such as glycolic acid, lactic acid, malic acid, citric acid and the like; carboxylic acids with a substituent such as sulfamic acid, β-chloropropionic acid, nicotinic acid, ascorbic acid, hydroxypivalic acid, levulinic acid and the like; derivatives thereof; and the like.

The content of the organic acid is preferably about 0.1 to 30%. When the content is too low, copper oxide cannot be sufficiently dissolved and thus an active copper surface cannot be obtained. When the content is too high, the dissolution stability of copper is lowered.

The halogen ions are incorporated for the purpose of assisting the dissolution of copper and the oxidizing power of the azole so as to create a copper surface having a high adhesiveness. Examples of the halogen ions include fluorine ions, chlorine ions, bromine ions and the like. These halogen ions may be added in the form of a compound which can be dissociated in, for example, an acid such as hydrochloric acid, hydrobromic acid or the like; a salt such as sodium chloride, calcium chloride, potassium chloride, ammonium chloride, potassium bromide or the like; a metallic salt such as copper chloride, zinc chloride, iron chloride, tin bromide or the like; or other chemical compounds which can be dissociated in solutions. The content of the halogen ions is preferably about 0.01 to 20%. When the content is too low, a highly adhesive copper surface cannot be obtained. When the content is too high, the dissolution stability of copper is lowered.

The surface roughening agent containing the above-described components may have a pH in the range of 1 or lower to about 8 in accordance with the type of organic acid or additives used. In order to decrease the change of pH which is caused by the use of the surface roughening agent, a salt such as a sodium salt, a potassium salt, an ammonium salt or the like of an organic acid may be added. To the surface roughening agent, a complexing agent for improving the dissolution stability of copper such as ethylenediamine, pyridine, aniline, ammonia, monoethanolamine, diethanolamine, triethanolamine, N-methyldiethanolamine or the like; or any of various other additives and the like for improving the adhesiveness of the copper surface may be added.

There is no specific limitation on the method for using the surface roughening agent. For example, a method of spraying the surface roughening agent to copper or a copper alloy to be treated, a method of immersing copper or a copper alloy in the surface roughening agent, or the like may be used. In the case where the immersion is used, in order to oxidize cuprous ions generated in the surface roughening agent by etching of copper or a copper alloy into cupric ions, air is blown by bubbling or the like. The treatment is performed preferably at a temperature of 30 to 50° C. for a time duration of about 10 to 120 seconds.

### Third Embodiment

### (Production of a Secondary Cell Electrode Using an Electrolytic Etching Method (1))

In the case where the current collector is formed of an aluminum foil, in order to perform DC etching on the current collector, it is preferable to apply a DC current having a current density of 100 to 500 mA/cm² and a quantity of electricity of 30 to 60 C/cm² in an aqueous solution containing 3 to 10% of hydrochloric acid and 0.05 to 1% of oxalic acid and having a solution temperature of 50 to 80° C.

In order to perform AC etching on the current collector formed of an aluminum foil, it is preferable to apply an AC current having a current density of 200 to 600 mA/cm², a frequency of 20 to 70 Hz and a quantity of electricity of 50 to 100 C/cm² in an aqueous solution containing 5 to 10% of hydrochloric acid, 0.5 to 2% of phosphoric acid and 0.1 to 1% of sulfuric acid and having a solution temperature of 30 to 50° C.

In the case where the current collector is formed of an aluminum foil, examples of compound usable as a positive electrode active substance include lithium-manganese composite oxides (LiₓMn₂O₄ or LiₓMnO₂), lithium-nickel composite oxides (LiₓNiO₂), lithium-cobalt composite oxides (LiₓCoO₂), lithium-nickel-cobalt composite oxides (LiNi_{1-y}Co_{y}O₂), lithium-manganese-cobalt composite oxides (LiMn_{y}Co_{1-y}O₂), spinel-structured lithium-manganese-nickel composite oxides (LiₓMn_{2-y}Ni_{y}O₄), olivine-structured lithium-phosphorus oxides (LiₓFePo₄, LiₓFe_{1-y}Mn_{y}PO₄, LiₓCoPO₄, etc.) and lithium sulfide (Li₂S). Additional examples of compound usable as a positive electrode active material include Li₂MnO₃, Li_{2-x-y}FeₓMn_{y}O₂, Li₂Fe₁₋ₓMnₓSiO₄, LiNi_{1/3}Mn_{1/3}Co_{1/3}O₂, manganese dioxide (MnO₂), an oxide of vanadium (V₂O₅) and the like. In the above-listed compounds, x and y are preferably in the range of higher than 0 and 1 or lower. As the positive electrode active substance, the above-listed compounds may be used independently or as a mixture of a plurality thereof. Needless to say, compounds usable as the positive electrode active substance are not limited to the above-listed compounds, and any other compound which can occlude and release lithium is usable.

In the case where the current collector is formed of an aluminum foil, lithium titanate (Li₄ti₅O₁₂) is usable as a negative electrode active substance.

The aluminum used for the current collector preferably has a purity of 99.99% or higher in order to improve the corrosion resistance and the strength. A preferably usable aluminum alloy contains at least one element selected from the group consisting of iron, magnesium, zinc, manganese and silicon, in addition to aluminum. For example, an Al—Fe alloy, an Al—Mn-based alloy or an Al—Mg-based alloy provides a higher strength than aluminum.

By contrast, the content of a transition metal such as nickel, chromium or the like in an aluminum alloy is preferably 100 ppm or lower (including 0 ppm). For example, an Al—Cu-based alloy raises the strength but lowers the corrosion resistance, and therefore is not suitable for a current collector. It is desirable that the content of aluminum in an aluminum alloy is 95% by weight or higher and 99.5% by weight or lower. A reason for this is that when the content of aluminum is outside this range, there is an undesirable possibility that a sufficient strength is not obtained. A more preferable content of aluminum is 98% by weight or higher and 99.5% by weight or lower.

There is no specific limitation on the thickness of the aluminum or aluminum alloy foil substrate, and the thickness may be appropriately selected in accordance with the use or required characteristics. In general, the thickness is 1 to 100 μm, but in the case where, for example, the substrate is used as a current collector of a lithium secondary cell, a thinner aluminum foil can provide a cell of a larger capacitance. From this viewpoint, the thickness is preferably 2 to 50 μm, and more preferably about 10 to 30 μm.

By contrast, in the case where the current collector is formed of a copper foil, there is no specific limitation on the negative electrode active substance as long as occlusion and release of lithium ions, desorption and insertion of lithium ions, or doping and dedoping of lithium ions and counter anions to the lithium ions (for example, ClO₄⁻) can reversibly proceed. Substantially the same substances as those used as an element of known lithium ion secondary cells can be used. Usable substances include, for example, carbon materials such as natural graphite, synthetic graphite, mesocarbon microbeads, mesocarbon fiber (MCF), cokes, glasslike carbon, burned organic compounds and the like; metals which can be combined with lithium, such as Al, Si, Sn and the like; amorphous compounds containing an oxide as a main component, such as SiO₂, SnO₂ and the like; Li₄Ti₅O₁₂; and the like.

There is no specific limitation on the type of copper or copper alloy used for the copper or copper alloy foil substrate. The type of copper or copper alloy may be appropriately selected in accordance with the use or required characteristics. For example, high purity copper (oxygen-free copper, tough pitch copper, etc.) may be used although the type of copper or copper alloy is not limited to these. Examples of the copper alloy used for the copper foil substrate include Cu—Ag-based, Cu—Te-based, Cu—Mg-based, Cu—Sn-based, Cu—Si-based, Cu—Mn-based, Cu—Be—Co-based, Cu—Ti-based, Cu—Ni—Si-based, Cu—Cr-based, Cu—Zr-based, Cu—Fe-based, Cu—Al-based, Cu—Zn-based, Cu—Co-based alloys and the like.

There is no specific limitation on the thickness of the copper or copper alloy foil substrate. The thickness may be appropriately selected in accordance with the use or required characteristics. In general, the thickness is 1 to 100 μm, but in the case where, for example, the substrate is used as a current collector of a negative electrode of a lithium secondary cell, a thinner copper foil can provide a cell of a larger capacitance. From this viewpoint, the thickness is preferably 2 to 50 μm, and more preferably about 5 to 20 μm.

Examples of substance usable as the binder include polytetrafluoroethylene (PTFE), poly(vinylidene difluoride) (PVDF), polyacrylonitrile (PAN), styrene-butadiene rubber (SBR) and the like; denatured materials or derivatives thereof; copolymers containing acrylonitrile; derivatives of polyacrylic acid; and the like. According to the present invention, in order to effectively express the anchor effect, it is preferable to use poly vinylidene fluoride (PVDF), styrene-butadiene rubber (SBR), copolymers containing acrylonitrile, derivatives of polyacrylic acid or the like which are appropriately swollen under coexistence with an electrolytic solution.

It is desirable to incorporate an auxiliary conductive agent into an active substance layer of the electrode because this provides a higher electron conductivity between the electrode active substance of each electrode active substance layer and the current collector with certainty and thus can lower the volume resistivity of the electrode active substance layer itself efficiently. As the auxiliary conductive agent, any substance which is usually used for an electrode plate for a nonaqueous electrolytic secondary cell is usable. Examples of the auxiliary conductive agent include conductive carbon materials such as particle-like carbon black, for example, acetylene black, Ketjen Black and the like. The conductive carbon materials preferably have an average primary particle diameter of about 20 nm to 50 nm.

As another auxiliary conductive agent, vapor grown carbon fiber (VGCF) is known. The carbon fiber can guide electricity well in a length direction thereof and thus can improve the fluidity of electricity. The carbon fiber has a fiber length of about 1 μm to 20 μm. Thus, by using carbon fiber in addition to the particle-like conductive agent such as acetylene black mentioned above or the like, the effect provided by adding the auxiliary conductive agent can be improved.

### EXAMPLES

Hereinafter, the present invention will be further described by way of specific examples, but the present invention is not limited to the following examples.

### (Production of a Positive Electrode)

A positive electrode was produced as follows. For obtaining olivine-type lithium iron phosphate (LiFePO₄) used as a positive electrode active substance, iron phosphate octahydrate (Fe₃(PO₄)₂.8H₂O) and lithium phosphate (Li₃PO₄) as raw materials of olivine-type lithium iron phosphate were mixed so as to have a molar ratio of 1:1. This mixture and stainless steel balls having a diameter of 1 cm were put into a stainless steel pot having a diameter of 10 cm, and were kneaded under the conditions of an orbital radius of 30 cm, an orbital speed of 150 rpm, and a rotational speed of 150 rpm for 12 hours. The resultant kneaded substance was burned at a temperature of 600° C. for 10 hours in an electric oven in a non-oxidizing atmosphere, pulverized and classified. As a result, lithium iron phosphate (LiFePO₄) having an average particle diameter of 100 nm was obtained.

90 parts by weight of obtained powdery lithium iron phosphate (LiFePO₄), 5 parts by weight of acetylene black (produced by Denki Kagaku Kogyo Kabushiki Kaisha, Denka Black) as an auxiliary conductive agent, and 5 parts by weight of poly(vinylidene difluoride) (PVdF) as a binder were mixed, and further an appropriate amount of a solution of N-methylpyrrolidone (NMP) as a solvent was added and mixed. As a result, a slurry was produced.

Next, the produced slurry was applied onto one surface of a positive electrode current collector formed of an aluminum foil (a1) and having a thickness of 20 μm by a doctor blade method such that the post-drying weight of the applied slurry would be 10.2 mg/cm². Then, the slurry was dried in a thermostat oven kept at 100° C. while NMP vapor was discharged, and thus NMP was volatilized. After being dried, the slurry was cut into a size of 2.5 cm×7 cm, rolled by use of a roller such that an active substance which has a prescribed filling density (1.9 g/cc) would be obtained, and then dried at 100° C. As a result, a positive electrode was produced.

### (Production of a Negative Electrode)

A negative electrode was produced as follows. Graphite as a negative electrode active substance, styrene-butadiene rubber (SBR) as a binder, and an aqueous solution containing carboxymethyl cellulose (CMC) as a thickener dissolved therein were kneaded after being prepared such that the weight ratio of the negative electrode active substance, the binder and the thickener would be 98:1:1. As a result, a negative electrode slurry was produced.

Next, the resultant negative electrode slurry was applied onto one surface of a negative electrode current collector formed of a copper foil and having a thickness of 10 μm such that the post-drying weight of the applied slurry would be 5.5 mg/cm². Then, the slurry was dried in a thermostat oven kept at 80° C., and thus water was volatilized. After being dried, the slurry was cut into a size of 2.7 cm×7.5 cm, rolled by use of a roller such that an active substance which has a prescribed filling density (1.3 g/cc) would be obtained, and then dried at 100° C. As a result, a negative electrode was produced.

### (Production of an Electrolytic Solution)

An electrolytic solution was produced by dissolving 1 mol/liter of LiPF₆ in a solvent containing ethylene carbonate (EC) and ethyl methyl carbonate (EMC) mixed at a volumetric ratio of 3:7. To 100 parts by weight of the resultant electrolytic solution, 1 part by weight of vinylene carbonate was mixed. Thus, an electrolytic solution to be used for a cell was produced.

### (Production of a Cell)

The positive electrode 2 and the negative electrode 3 produced in the above-described methods were each cut into a prescribed size. Current collecting tabs 2a and 3a were respectively attached to the metal foils as the current collectors. A separator 4 formed of a polyolefin-based micro porous film and having a thickness of 20 μm was held between these electrodes to form a layered body, and this was used as a flat-plate electrode body. The flat-plate electrode body was inserted into an outer casing 5 formed of a laminated body produced by stacking PET (polyethylene terephthalate) and aluminum, such that the current colleting tabs 2c and 3c were projected outward from an opening, and then a sealing section 5a l of the outer casing 5 was sealed.

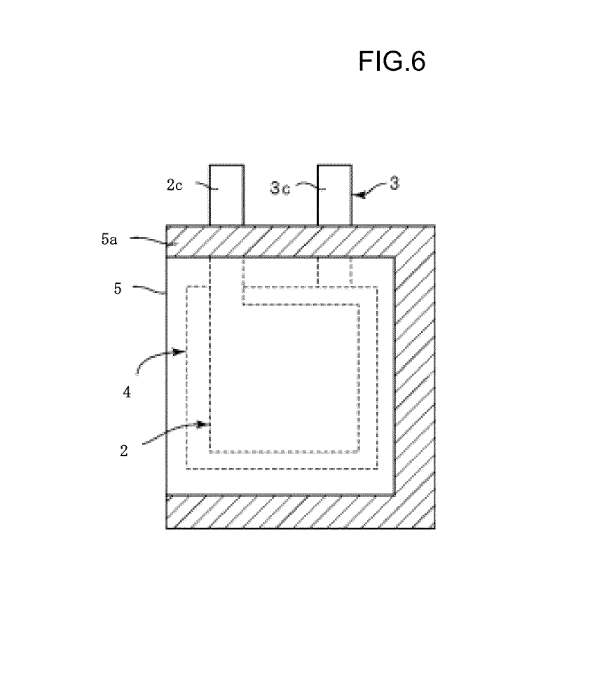

Next, 0.35 ml of the above-produced electrolytic solution was injected through the opening of the outer casing 5, and the opening was sealed. Thus, comparative cell 1 shown in FIG. 6 was produced.

Current collectors b1, b2 c1 through c3, and d1 through d4 were produced in the same manner as the current collector al except that the surface roughness Ra and the roughening method shown in Table 1 were adopted. Inventive cells 1 through 5 according to the present invention and comparative cells 2 through 5 respectively including these current collectors were produced.

### (Evaluation on Charge/Discharge Characteristics of the Cells)

The charge/discharge characteristics of the cells produced above were evaluated as follows. Each cell was charged at a constant current of 9 mA until an upper-limit voltage of 3.8 V was obtained, and then was discharged at a constant current of 9 mA until the voltage was decreased to a lower-limit voltage of 2.0 V, in the environment of room temperature.

### (Evaluation by a Charge Conservation Test on the Cells)

Charge conservation characteristics of the cells were evaluated. Each cell was charged at a constant current of 9 mA until an upper-limit voltage of 3.8 V was obtained, and then the internal resistance of the cell was measured as a pre-conservation test internal resistance. After the cell was conserved in a thermostat oven of 60° C. for 15 days, the internal resistance of the cell was measured as a post-conservation test internal resistance.

TABLE 1

| | Current | | | Surface roughness | Pre-conservation | Post-conservation |
|---|---|---|---|---|---|---|
| | collector | Roughening | Warped | of current | test internal | test internal |
| | No. | method | shape | collector (Ra) (μm) | resistance (Ω) | resistance (Ω) |
| Comparative | a1 | N/A | NO | 0.08 | 2.07 | 3.05 |
| cell 1 | | | | | | |
| Comparative | b1 | Blasting | NO | 0.11 | 1.85 | 2.65 |
| cell 2 | | | | | | |
| Comparative | b2 | Blasting | NO | 0.22 | 1.24 | 2.51 |
| cell 3 | | | | | | |
| Comparative | c1 | Chemical | NO | 0.23 | 1.11 | 1.91 |
| cell 4 | | etching | | | | |
| Inventive cell 1 | c2 | Chemical | YES | 0.21 | 0.65 | 0.94 |
| | | etching | | | | |
| Inventive cell 2 | c3 | Chemical | YES | 0.41 | 0.61 | 0.82 |
| | | etching | | | | |
| Comparative | d1 | Electrolytic | NO | 0.21 | 1.17 | 1.52 |
| cell 5 | | etching | | | | |
| Inventive cell 3 | d2 | Electrolytic | YES | 0.33 | 0.59 | 0.85 |
| | | etching | | | | |
| Inventive cell 4 | d3 | Electrolytic | YES | 0.48 | 0.44 | 0.51 |
| | | etching | | | | |
| Inventive cell 5 | d4 | Electrolytic | YES | 0.56 | 0.41 | 0.43 |
| | | etching | | | | |

As is clear from Table 1, in each of the cells including the current collectors produced by the blasting method, the internal resistance was decreased as Ra was increased. This result is considered to be an effect provided by an increase of the surface area as a result of the blasting treatment. By contrast, after these cells were conserved at 60° C. for 15 days, the internal resistance was increased to about twice as high. From this, it is estimated that the mix layer was detached from the surface of the current collector.

By contrast, as is clear from Table 1, in each of inventive cells 1 through 5 including current collectors c2, c3, d2, d3 and d4 having a warped shape at the opening of the first concaved portion in the surface of the current collector, even after each cell was conserved in the thermostat oven of 60° C. for 15 days, the internal resistance was kept lower than that of comparative cells 1 through 5 each including the current collector having no warped shape in the first concaved portion formed in the surface of the current collector.

This is considered to be an effect provided by, in addition to an increase of the surface area, the warped shape formed at the opening of the first concaved portion in the surface of the current collector and by the binder, which is contained in the first concaved portion and swollen by coexistence with an electrolytic solution.

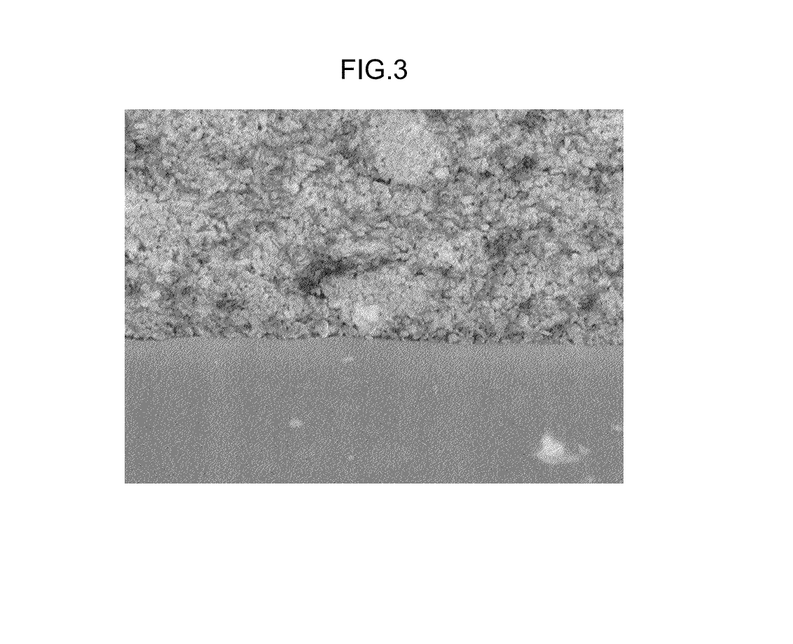

FIG. 3 through FIG. 5 respectively show images of cross-sections of the electrodes of comparative cell 1, inventive cell 1 and inventive cell 5, which are observed by an SEM.

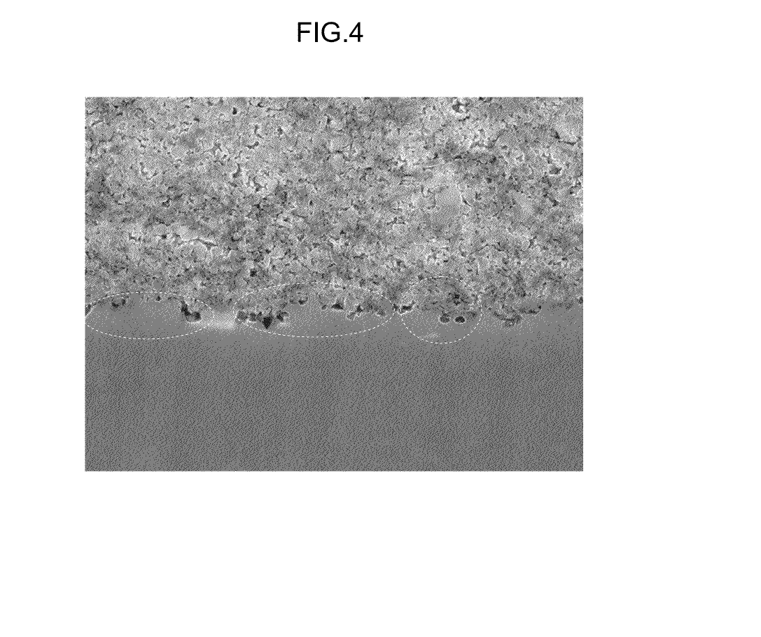

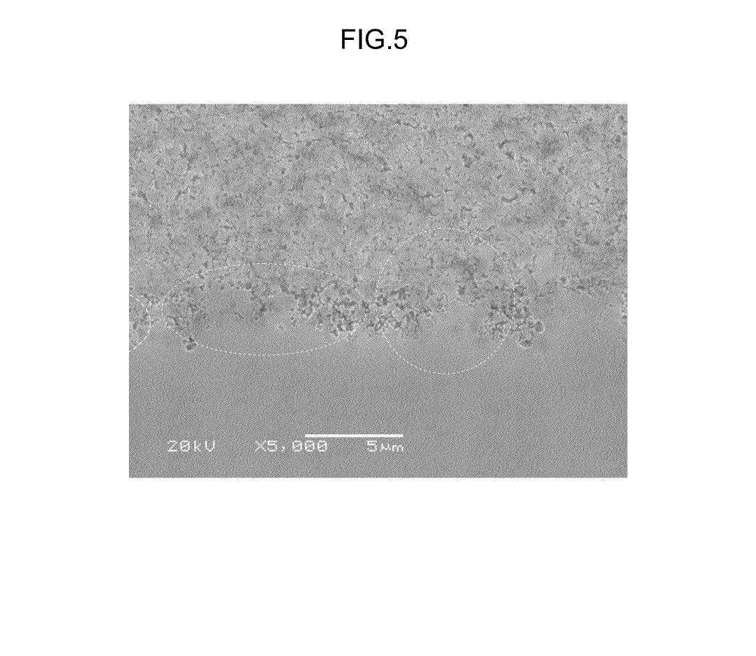

As shown in FIG. 3, the current collector and the mix layer of comparative cell 1 contact each other along an almost flat border face. By contrast, as shown in FIG. 4 and FIG. 5, in each of the electrodes of inventive cell 1 and inventive cell 2, the mix layer eats into current collector c2 or d4 as being rooted in the vicinity of the surface thereof. In FIG. 4 and FIG. 5, in the areas enclosed by the white dashed line, the anchor effect described above is especially expressed.

In the comparative cell shown in FIG. 3, the surface of the current collector has almost no concaved and convexed portions. Therefore, the binder or the mixture of the binder and the active substance is detached or flows easily. By contrast, as shown in FIG. 4 and FIG. 5, the inventive cells according to the present invention each have a structure in which the mix layer is rooted into the current collector. Therefore; the adhesiveness between the mix layer and the current collector can be improved.

### (Evaluation on the Surface-Roughened Al Foils Formed by Chemical Etching)

The cell characteristics were evaluated as described below. What was evaluated specifically was, when the Al foil was used as a current collector of a positive electrode, what effect was exerted, on the adhesiveness of the mix layer to the Al foil and on the high-rate discharge characteristic, by the roughening treatment conducted on the aluminum foil (Al foil) surface by chemical etching.

Positive electrodes were produced by applying a slurry of a mixture containing an active substance, carbon and PVdF onto various types of Al foils shown in Table 2.

Cells were each produced as a laminated pouch cell by assembling each of the positive electrodes produced using the various types of Al foils shown in Table 2, a negative electrode formed of graphite and a separator. The high-rate discharge characteristic of each of the produced cells was evaluated. Nonaqueous electrolytic secondary cells, specifically, inventive cell 1, inventive cell 2 and comparative cell 1 produced as described above were each charged at a constant current of 9 mA until a voltage of 3.8 V was obtained, and further charged at a constant voltage of 3.8 V until a current value of 0.9 mA was obtained, at room temperature. After a 10-minute pause, each cell was discharged at a constant current of 9 mA until the voltage was decreased to 2.0 V. Then, each cell was charged at a constant current of 9 mA until a voltage of 3.8 V was obtained, and further charged at a constant voltage of 3.8 V until a current value of 0.9 mA was obtained. After a 10-minute pause, each cell was processed with high-rate discharge of discharging the cell at a constant current of 180 mA until the voltage was decreased to 2.0 V. The value of (discharge capacitance at 180 mA/discharge capacitance at 9 mA)×100 was used as an index of the high-rate discharge characteristic.

TABLE 2

| | Current | | Surface roughness of | | Average discharge voltage |
|---|---|---|---|---|---|
| | collector | Roughening | current collector (Ra) | High-rate discharge | when discharged at |
| Cell | No. | method | (μm) | characteristic (%) | 180 mA (V) |
| Comparative | a1 | N/A | 0.08 | 75.7 | 2.659 |
| cell 1 | | | | | |
| Inventive cell 1 | c2 | Chemical | 0.21 | 88.9 | 2.746 |
| | | etching | | | |
| Inventive cell 2 | c3 | Chemical | 0.41 | 89.1 | 2.767 |
| | | etching | | | |

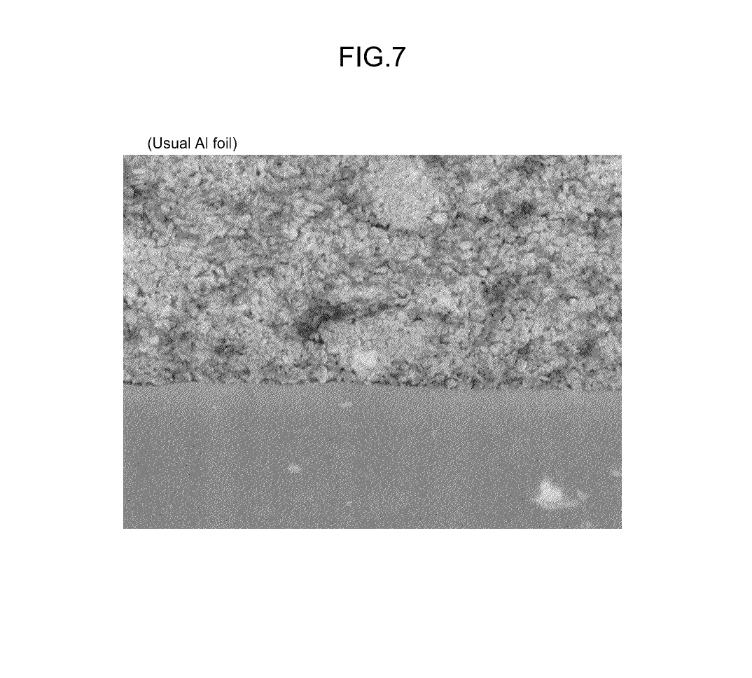

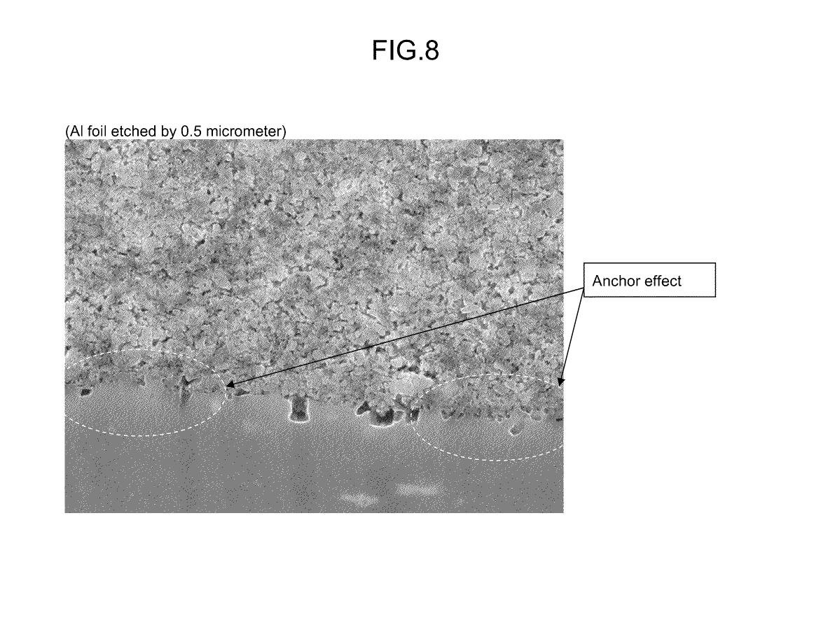

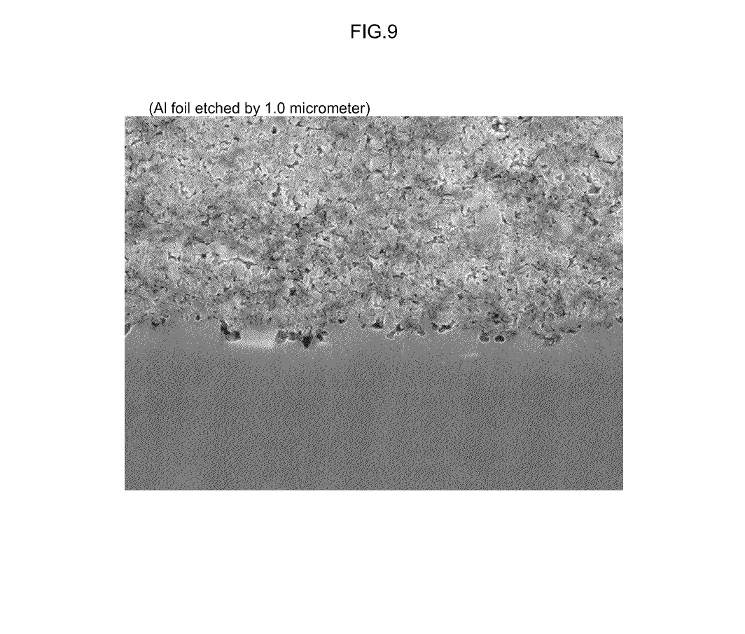

FIG. 7 through FIG. 9 respectively show cross-sections of electrodes using the current collectors a1, c2 and c3 in Table 2, which are observed by an SEM.

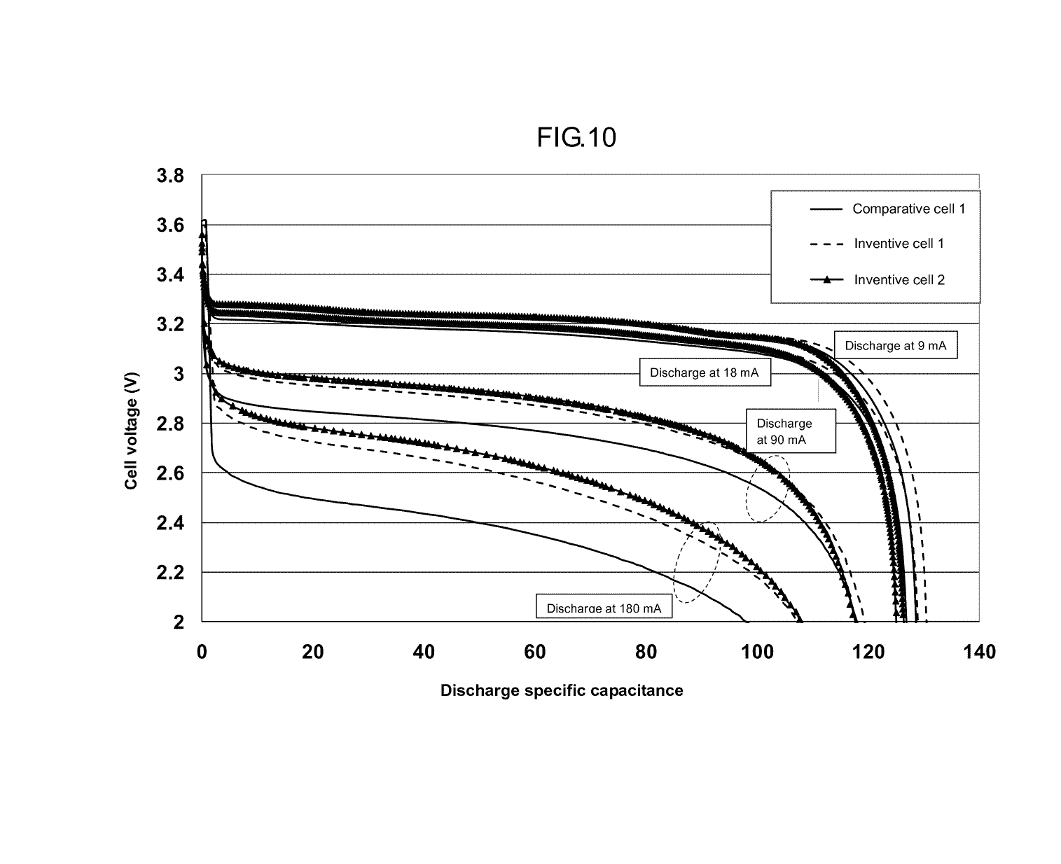

On comparative cell 1, inventive cell 1 and inventive cell 2 shown in Table 2, a low-rate discharge test and a high-rate discharge test were performed. The results are shown in FIG. 10.

As understood from FIG. 10, in the low-rate discharge test performed at 9 mA and 18 mA, equivalent cell characteristics were exhibited regardless of the type of Al foil used. According to such results, it is considered that the etched Al foils are not advantageous over the non-etched Al foil. However, in the high-rate discharge test performed at 90 mA and 180 mA, it is understood that use of an etched Al foil suppresses reduction of the voltage, which would occur due to the internal resistance of the cell.

When being discharged by high-rate discharge (90 mA or 180 mA), the voltage of a cell having a high internal resistance is rapidly lowered. With the current collector a1, the adhesiveness between the active substance layer and the current collector is insufficient and therefore the internal resistance of the cell is high. Thus, when the cell is discharged by high-rate discharge, the voltage of the cell is significantly lowered. By contrast, when the current collector c2 or c3 is used, since the adhesiveness between the active substance layer and the current collector is high, the internal resistance of the cell is low. Thus, when the cell is discharged by high-rate discharge, reduction of the voltage of the cell can be suppressed small.

From the above, it is considered that the reason that the reduction of the voltage is suppressed small is that use of an etched foil improves the adhesiveness at the interface between the active substance and the Al foil in the positive electrode, and thus decreases the contact resistance at the interface. As described above, etching performed on the surface of the current collector provides an effect on the high-rate discharge characteristic, and thus the etched Al foil is recognized to be advantageous.

1. A secondary cell electrode, comprising:
a mix layer comprising an active substance, a conductive agent, and a binder; and
a current collector comprising a conductive metal foil, the mix layer being located directly on the current collector;
wherein:
the current collector has, in a surface thereof, a first concaved portion which is opened and a first convexed portion forming a wall of the first concaved portion;
at least a part of a side surface of at least either one of the first concaved portion and the first convexed portion includes at least either one of a second concaved portion and a second convexed portion; and
a mixture containing at least either one of the binder, the conductive material and the active substance is put into a space in the first concaved portion.

2. The secondary cell electrode according to claim 1, wherein the surface of the current collector has a surface roughness (Ra) of 0.21 μm or larger.

3. The secondary cell electrode according to claim 1, wherein the secondary cell electrode is a component of at least either one of a positive electrode and a negative electrode.

4. A method for producing a secondary cell electrode, comprising:
mixing a mixture, comprising an active substance, a conductive agent, and a binder which is swollen by coexistence with an electrolytic solution and thus has a volume thereof increased, in a solvent to produce a slurry;
applying the slurry onto a surface of a current collector having concaved and convexed portions in which at least a part of a side surface of at least either one of a first concaved portion and a first convexed portion has at least either one of a second concaved portion and a second convexed portion; and
drying the current collector having the slurry applied onto the surface thereof to form a mix layer.

5. The secondary cell electrode according to claim 2, wherein the secondary cell electrode is a component of at least either one of a positive electrode and a negative electrode.
